(19) United States
(12) Patent Application Publication
(10) Pub. No.: US 2024/0082790 A1
(43) Pub. Date: Mar. 14, 2024

(54) FILTRATION MEMBRANE FROM A BLEND COMPRISING POLYSULFONE AND POLYOXAZOLINE AND METHOD MAKING THEREOF

(71) Applicant: 3M INNOVATIVE PROPERTIES COMPANY, St. Paul, MN (US)

(72) Inventors: Ramona Osterloh, Velbert (DE); Daniel P. Malek, Wuppertal (DE); Mathias Stroschke, Sprockhövel (DE); Bartlomiej Kowalczyk, East Hampton, CT (US); Christian Krumm, Solingen (DE); Oliver Schuster, Gevelsberg (DE); Pierre-Alexandre Bourgeois, Essen (DE); Manfred Trussner, Radevormwald (DE)

(21) Appl. No.: 18/280,146

(22) PCT Filed: Mar. 10, 2022
(86) PCT No.: PCT/IB2022/052169

§ 371 Date: Sep. 1, 2023

Related U.S. Application Data
(60) Provisional application No. 63/167,768, filed on Mar. 30, 2021.

(51) Int. Cl. B01D 67/00; B01D 63/08; B01D 69/02; B01D 69/06; B01D 71/58; B01D 71/68

(52) U.S. Cl. CPC B01D 67/0011; B01D 63/082; B01D 67/0016; B01D 69/02; B01D 69/06; B01D 71/58; B01D 71/68; B01D 2323/02; B01D 2325/0212; B01D 2325/0233; B01D 2325/20; B01D 2325/28; B01D 2325/36

(57) ABSTRACT

An asymmetric membrane. The asymmetric membrane includes a membrane wall with a first and a second porous surface and an interior situated between the surfaces; a first asymmetrical region towards the first surface; a second asymmetrical region towards the second surface; wherein the asymmetric membrane is made from a polymeric blend comprising an aromatic sulfone polymer and poly (2-oxazoline); and wherein the asymmetric membrane is in the form of a flat sheet.

### BACKGROUND

Microporous polymer membranes are used in a wide range of industrial, pharmaceutical, or medical applications for high-precision filtration. In these applications, membrane separation processes are gaining increasingly in importance, as these processes offer the advantage that the substances to be separated are not thermally stressed or affected. Microfiltration membranes enable, for example, the removal of fine particles or micro-organisms in sizes down to the submicron range and are therefore suitable for producing purified water for use in laboratories or for the semi-conductor industry. Numerous further applications of membrane separation processes are known from the beverage industry, biotechnology sector, or wastewater technology.

### SUMMARY

Thus, in one aspect, the present disclosure provides an asymmetric membrane comprising: a membrane wall with a first and a second porous surface and an interior situated between the surfaces; a first asymmetrical region towards the first surface; a second asymmetrical region towards the second surface; wherein the asymmetric membrane is made from a polymeric blend comprising an aromatic sulfone polymer and a poly(2-oxazoline); and wherein the asymmetric membrane is in the form of a flat sheet.

In another aspect, the present disclosure provides a method, the method comprising: producing a casting solution comprising an aromatic sulfone polymer and a poly(2-oxazoline), conditioning the casting solution to a casting temperature; pouring the casting solution onto a carrier to form a film; conveying the film located on the carrier through a climate-controlled zone; introducing the film located on the carrier into a coagulation medium and initiating the coagulation of the film for the formation of a membrane structure; and stabilizing the membrane structure in the coagulation medium.

### BRIEF DESCRIPTION OF THE DRAWINGS

FIG. 1 is SEM image showing a cross-section of the membrane of Example 1

FIG. 2 is SEM image showing a cross-section of the membrane of Example 2

FIG. 3 is SEM image showing a cross-section of the membrane of Example 3

FIG. 4 is SEM image showing a cross-section of the membrane of Example 4

### DETAILED DESCRIPTION

Before any embodiments of the present disclosure are explained in detail, it is understood that the invention is not limited in its application to the details of use, construction, and the arrangement of components set forth in the following description. The invention is capable of other embodiments and of being practiced or of being carried out in various ways that will become apparent to a person of ordinary skill in the art upon reading the present disclosure. Also, it is understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. It is understood that other embodiments may be utilized and structural or logical changes may be made without departing from the scope of the present disclosure.

The present disclosure provides an integrally asymmetric membrane in the form of a flat sheet, in particular for filtration, made from a polymeric blend comprising aromatic sulfone polymers and a poly(2-oxazoline), the membrane having a membrane wall with a first and a second porous surface and an interior situated between the surfaces, possessing a porous structure with a pore size distribution over the membrane wall, and having a first asymmetrical region towards the first surface and, towards the second surface, a second asymmetrical region. In some embodiments, the asymmetric membrane can be in the form of a flat sheet.

Asymmetric membranes generally have a separating layer with a minimal pore size that determines the separation characteristics of the membrane, and a supporting layer with larger pores that is responsible for the mechanical stability of the membrane. An integrally asymmetric membrane is understood to be one having at least one separating layer or region and one supporting layer or region, the separating and supporting layers consisting of the same material and being formed simultaneously during the production of the membrane. As a result, both layers are bound together as an integral unit. At the transition from the separating layer to the supporting layer there is merely a change with respect to the membrane structure, for example, the pore size. Integrally asymmetric membranes and methods for their production are described e.g. in EP 0361 085 B1.

The membrane may have an essentially isotropic region between the first asymmetrical region and the second asymmetrical region. Within the context of the present disclosure, an essentially isotropic region is understood to be a region of the membrane wall with an essentially constant pore size, whereby an assessment is carried out by means of scanning or transmission electron microscope images. The isotropic region can also be regarded as a region in which the flow channels extending through the membrane wall have an essentially constant average diameter. As it is true for every membrane, the actual pore size also varies somewhat in the membrane according to the invention, i.e. it has a certain pore size distribution, even when the pore size distribution appears visually isotropic. Therefore, in some embodiments, in the essentially isotropic region, the pore size changes by a maximum of approx. 15-20%. Due to the preferred existence of an isotropic region, in which the pore size does not increase further, an improvement of the mechanical stability is achieved while simultaneously retaining a high dirt-loading capacity.

In some embodiments, the pore size of the first asymmetrical region can be larger than the pore size of the second asymmetrical region. In some embodiments, the average pore size of the first asymmetrical region can be larger than the average pore size of the second asymmetrical region. The average diameter of the pores in the first asymmetrical region can be 2 to 50 μm. The average diameter of the pores in the second asymmetrical region can be 2 to 40 μm. In some embodiments, the pore size of the first asymmetrical region can be from 0.1 to 30 μm, or 0.1 to 15 μm. In some embodiments, the pore size of the second asymmetrical region can be from 0.1 to 10 μm or 0.1 to 5 μm. In some embodiments, the pore size of the isotropic region is larger than the pore size of the first asymmetrical region and the pore size of the second asymmetrical region. In some embodiments, the average pore size of the isotropic region is larger than the average pore size of the first asymmetrical region and the average pore size of the second asymmetrical region. In some embodiments, the average pore size of the isotropic region is less than the average pore size of the first asymmetrical region and the average pore size of the second asymmetrical region.

Average pore diameter or pore size of the pores can be determined, for example, by the method described in US 2017/0304780 (Asahi et al.) Average pore diameter or pore size of the pores can be determined by photographing a cross-section of the membrane by a scanning electron microscope (SEM). For example, the photographing magnification is set at 50,000×, and the field of view is set on a cross-section perpendicular to the length direction of the membrane or a cross-section parallel to the length direction and passing through the center of the membrane, horizontally to the cross-section. After photographing the initially set field of view, the photographing field of view is moved horizontally in the membrane thickness direction, and the next field of view is photographed.

This photographing operation is repeated until photographs of the cross-section of the membrane crossing from the outer surface to the inner surface are taken without a gap, and the obtained photographs are combined to obtain one membrane cross-section photograph. In this cross-section photograph, the average pore diameter of the pores in each area of (2 μm in the circumferential direction of the membrane)×(1 μm from the outer surface toward the inner surface side) from the outer surface toward the inner surface side is calculated, and the gradient structure of the membrane cross-section is quantified for each 1 μm from the outer surface toward the inner surface side. By such quantification, it can be determined as to whether or not the membrane has a gradient-type porous structure.

The average pore diameter or pore size can be calculated by a method using image analysis. Specifically, binarization processing for pore portions and solid portions is performed using Image-pro plus manufactured by Media Cybernetics, Inc. The identification between a pore portion and a solid portion is based on their brightness, and a portion that cannot be identified and a noise are corrected by a free hand tool. An edge portion forming the outline of a pore portion, and a porous structure observed behind a pore portion are identified as pore portions. After the binarization processing, the diameter of a pore is calculated from the area value of the pore assuming that the pore is a perfect circle. The calculation is carried out for each of all pores, and the average pore diameter is calculated for each area of 1 μm×2 μm. A pore portion that is located at the end of the field of view and is partially in the field of view is also counted (i.e. its diameter is calculated assuming that the area of a pore portion partially in the field of view is the area of one whole perfect circle).

The aromatic sulfone polymers and the poly(2-oxazoline) may be distributed throughout the membrane. The aromatic sulfone polymer and the poly(2-oxazoline) may be evenly distributed throughout the membrane. The aromatic sulfone polymer and the poly(2-oxazoline) may be uniformly distributed throughout the membrane.

The membrane may have the aromatic sulfone polymers and the poly(2-oxazoline) distributed throughout at least one of the first asymmetrical region, the second asymmetrical region, and the isotropic region.

The aromatic sulfone polymer of the present disclosure, e.g. polysulfones, polyethersulfones, polyphenylene sulfones, polyarylethersulfones or copolymers or modifications of these polymers or mixtures of these polymers can be used. In a preferred embodiment, the aromatic sulfone polymer can be a polysulfone or a polyethersulfone with the repeating molecular units shown in formulas (I) and (II) as follows:

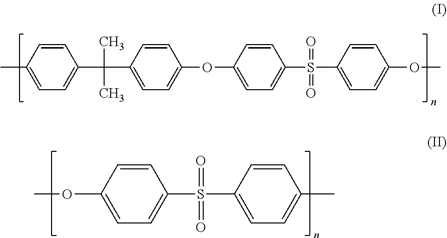

More preferably, a polyethersulfone according to formula (II) is used as the aromatic sulfone polymer can be, because this has lower hydrophobicity than, for example, the polysulfone. The polyethersulfone may have a molecular weight (MW) of from about 72 kg/mol.

In some embodiments, the poly(2-oxazoline) of the present disclosure can be poly(2-ethyl-2-oxazoline) (PEtOx). Poly(2-ethyl-2-oxazoline) has high potential for protein repulsion. The residual groups of poly(2-oxazoline) in general can be changed, to alter the properties of the polymers, e.g. from hydrophilic to hydrophobic. The poly(2-oxazoline) may have a molecular weight of from about 25 kg/mol to about 500 kg/mol. The poly(2-oxazoline) may have a molecular weight of from about 50 kg/mol.

The poly(2-ethyl-2-oxazoline) can have a molecular weight of from about 25 kg/mol to about 500 kg/mol. The poly(2-ethyl-2-oxazoline) can have a molecular weight of from about 25 kg/mol to about 100 kg/mol. The poly(2-ethyl-2-oxazoline) can have a molecular weight of about 50 kg/mol.

In some embodiments, the poly(2-oxazoline) of the present disclosure can be prepared by cationic ring opening polymerization reactions of various 2-oxazoline monomers. Polymerization of 2-alkyl substituted 2-oxazoline monomers provides poly(2-alkyl-2-oxazolines).

The poly(2-oxazoline) can be present in a concentration of 0.05 to 30 wt. % (weight percent), 0.5 to 30 wt. %, 1 to 30 wt. %, 5 to 30 wt. %, or 10 to 30 wt. % relative to the weight of the membrane. The poly(2-oxazoline) can be present in a concentration of more than 0.05 wt. %, more than 0.5 wt. %, more than 1 wt. %, more than 2 wt. %, more than 3 wt. %, more than 4 wt. %, more than 5 wt. %, more than 6 wt. %, more than 7 wt. %, more than 8 wt. %, more than 9 wt. %, more than 10 wt. %, more than 15 wt. %, or more than 20 wt. % relative to the weight of the membrane. The poly(2-oxazoline) can be present in a concentration of less than 30 wt. %, less than 28 wt. %, less than 25 wt. %, less than 23 wt. %, less than 20 wt. %, less than 15 wt. %, or less than 10 wt. % relative to the weight of the membrane.

The poly(2-oxazoline) may be distributed throughout the membrane. The poly(2-oxazoline) may be evenly distributed throughout the membrane. The poly(2-oxazoline) may be uniformly distributed throughout the membrane.

The membrane may have poly(2-oxazoline) distributed throughout at least one of the first asymmetrical region, the second asymmetrical region, and the isotropic region.

In some embodiments, the polymeric blend may further include a hydrophilic polymer. Exemplary hydrophilic polymer can include polyvinylpyrrolidone, polyethylene glycol, polyvinyl alcohol, polyglycol monoester, polysorbitate, carboxymethylcellulose, polyacrylic acid, polyacrylate, or a modification or a copolymer of these polymers. In some embodiments, the hydrophilic polymer can be polyethylene glycol. In some embodiments, the polymeric blend does not comprise polyvinylpyrrolidone. In some embodiments, the polymeric blend can be a hydrophobic polymeric blend. In some embodiments, the hydrophilic polymer can be present in a concentration of 1 to 75 wt. % relative to the weight of the membrane

In some embodiments, the polymeric blend may include a solvent. Exemplary solvent can include glycol, butyrolactone, caprolactam, or combination thereof. In some embodiments, the polymeric blend can include more than 7 wt. %, more than 10 wt. %, more than 20 wt. %, more than 30 wt. %, more than 40 wt. %, more than 50 wt. %, more than 60 wt. %, more than 70 wt. %, more than 80 wt. %, or more than 90 wt. % of polyvinylpyrrolidone. In some embodiments, the polymeric blend can include less than 3 wt. %, less than 2 wt. % or less than 1 wt. % of polyvinylpyrrolidone.

In some embodiments, a membrane combination is provided. The membrane combination can include at least two asymmetric membranes of the present disclosure. The at least two asymmetric membranes are stacked adjacent to each other.

The present disclosure also provides a method for producing the membrane, the method comprising the following steps: producing a homogeneous casting solution comprising an aromatic sulfone polymer and poly(2-oxazoline); conditioning the homogeneous casting solution to a casting temperature; pouring the homogeneous casting solution onto a carrier to form a film, which carrier can be temperature controlled and has a different temperature or a same temperature as the casting temperature of the casting solution, and which carrier has a speed v₁; conveying the film located on the carrier through a climate-controlled zone; introducing the film located on the carrier into a coagulation medium and initiating the coagulation of the film for the formation of a membrane structure; withdrawing the membrane structure from the carrier within the coagulation medium by means of withdrawal device moving with a speed of v₂, by which means the membrane structure is drawn; stabilizing the membrane structure in the coagulation medium; and extracting the resulting membrane and subsequently drying the membrane.

The method may further include stretching the membrane structure by adjusting the speed v₂ being greater than the speed v₁ of the carrier. In some embodiments, the membrane structure is stretched up to 10%, 15%, 20%, 25%, 30%, 35%, 40%, 45% or 50%. Stretching the membrane structure may result an internal stress on the membrane cross-section. In some embodiments, the stress on the two different surfaces of the membrane is not equal. The resulting stress is higher on the side that is facing the carrier and therefore this very side ends up with the first asymmetrical region towards this first surface, which has larger pore size. Therefore, this first side is usually used as the upstream side of the membrane in the filtration process. The pores in the second asymmetrical region that is towards the second surface (downstream side) are smaller than pores in the first asymmetrical region towards the first surface (the upstream side). In some embodiments, the pore size of the first asymmetrical region is more than 2 times, more than 3 times, more than 4 times, more than 5 times, more than 6 times, more than 7 times, more than 8 times, more than 9 times, or more than 10 times larger than the pore size of the second asymmetrical region. An open upstream side (larger pore size in the first asymmetrical region towards the first surface) can provide a good throughput performance.

Stretching the membrane in one direction results in pores in the first and second asymmetrical regions that are oriented in the direction of stretching. Stretching the membrane in one direction results in pores in the first and second asymmetrical regions that are elongated in the direction of stretching, for example, resulting in oval shape pores. In some embodiments, the elongated pores have an elliptical cross-section. For elongated pores, the longest dimension of the pore opening is oriented in the direction of stretching. In some embodiments, the elongated pores are at the first and second surfaces of the membrane. In some embodiments, pores in the first and second asymmetrical regions can be elongated in a same or different direction.

In some embodiments, the first asymmetrical region extends from the outer edge of the inner isotropic region to the first (upstream) surface of the membrane. In some embodiments, the second asymmetrical region extends from the outer edge of the inner isotropic region to the second (downstream) surface of the membrane.

In some embodiments the average pore size of pores in the first asymmetrical region decreases in the direction from the first surface of the membrane to the interior of the membrane. In some embodiments the average pore size of pores in the second asymmetrical region decreases in the direction from the second surface of the membrane to the interior of the membrane. In some embodiments the average pore size of pores in the first asymmetrical region increases in the direction from the first surface of the membrane to the interior of the membrane. In some embodiments the average pore size of pores in the second asymmetrical region increases in the direction from the second surface of the membrane to the interior of the membrane.

The casting solution may include a hydrophilic polymer. Exemplary hydrophilic polymer can include polyvinylpyrrolidone, polyethylene glycol, polyvinyl alcohol, polyglycol monoester, polysorbitate, carboxymethylcellulose, polyacrylic acid, polyacrylate, or a modification or a copolymer of these polymers. In some embodiments, the hydrophilic polymer can be polyethylene glycol. In some embodiments, the casting solution does not comprise polyvinylpyrrolidone.

The casting solution may include a solvent. The solvent system used for the preparation of the casting solution is to be adapted to the membrane-forming sulfone polymer. Preferably, the solvent system comprises polar, aprotic solvents like dimethylformamide, dimethylacetamide, dimethyl sulfoxide, N-methylpyrrolidone, γ-butyrolactone or a mixture of these, or protic solvents like ε-butyrolactone. Additionally, the solvent system can contain up to 80 wt. % of latent solvent, whereby in the context of the present invention a latent solvent is understood as a solvent that dissolves the sulfone polymer poorly or only at increased temperature. In the case of using ε-butyrolactone as the solvent, for example γ-butyrolactone, propylene carbonate, polyalkylene glycol can be used. In addition to this, the solvent system can contain non-solvents for the membrane-forming polymer, like, e.g., water, glycerin, low-molecular polyethylene glycols with a weight average of the molecular weight of less than 1,600 daltons or low-molecular alcohols, such as ethanol or isopropanol.

For the realization of the method according to the invention and for the formation of the characteristic structure of the membrane according to the invention, it is advantageous if the viscosity of the casting solution is set to a value below 30 Pa s, and more advantageous if it is set to a value below 20 Pa s, whereby the viscosity is determined at 60° C. The setting of the viscosity can occur in particular through the selection and concentration of the hydrophilic second polymer used in the method according to the invention.

The pouring of the casting solution to form a film can take place according to methods known per se, for example by means of conventional forming tools like sheeting dies, casting molds, or doctor blades. At the latest, the casting solution is set to the molding temperature in the forming tool. The pouring of the casting solution takes place on a carrier that can be temperature controlled; here also, one can resort to the conventional carriers, from which the coagulated membrane can be withdrawn later. For example, coated papers or steel tapes can be used. Preferably, the temperature-controllable carrier is a heating roll that can be temperature controlled, i.e. a casting roller, onto which the film is poured.

The temperature of the carrier can be different from the casting temperature of the casting solution. In some embodiments, the temperature of the carrier is higher than the casting temperature of the casting solution. By this means, a viscosity gradient develops in the casting solution over the thickness of the poured film. Due to the increased carrier temperature, the poured film has a lower viscosity in the region of the carrier, by which means coarser-pored structures are formed during later contact with the coagulation medium. In some embodiments, the carrier temperature is preferably at least 15° C. and more preferably at least 20° C. higher than the casting temperature.

In order to create the asymmetric structure, the film located on the carrier can be conveyed through a climate-controlled zone, in which a defined temperature and a defined relative humidity are set. Preferably, the temperature in the climate-controlled zone lies in the range from 25-60° C., the relative humidity is set preferably to values in the range from 20-95%. The retention time of the film in the climate-controlled zone as well as the overflow speed of the air over the poured film in the climate-controlled zone is to be determined such that a pre-coagulation is induced by pickup of the air humidity acting as a non-solvent.

After passing through the climate-controlled zone, the film located on the carrier is introduced into a coagulation medium and a coagulation for the formation of the membrane structure is initiated. Preferably, the coagulation medium is conditioned to a temperature above room temperature and has more preferably a temperature above 30° C. In a preferred embodiment of the method according to the invention, the coagulation medium is water or a water bath.

In the coagulation medium, the film is initially precipitated to form the membrane structure to the extent that the membrane structure already has a sufficient stability and can be withdrawn from the carrier, i.e. preferably from the casting roller. The withdrawal from the casting roller occurs by means of a withdrawal device, for example by means of a drawing-off roller, whereby according to the invention the withdrawal speed v₂ is greater than the speed v₁ of the carrier and the membrane structure is drawn. Preferably, the ratio of the speed v₂ of the withdrawal device to the speed v₁ of the carrier lies in the range between 1.01:1 and 1.5:1. By this means, a high surface porosity is achieved on the side of the resulting membrane that faced towards the carrier.

Following the withdrawal device, the coagulation is completed in the subsequent coagulation baths and the membrane is stabilized. These coagulation baths can have a higher temperature in comparison to the first, previously described coagulation bath. The temperature can also be increased stepwise from bath to bath. In the coagulation baths thereby simultaneously occurs an extraction of the solvent system and, normally, of parts of the hydrophilic second polymer from the membrane structure, so that the coagulation baths function simultaneously as wash or extraction baths. As a coagulation or wash medium in these coagulation or wash baths, water is preferably used.

In some embodiments, the casting solution can have 10-70 wt. %, relative to the weight of the solution, of the aromatic sulfone polymer and 5-30 wt. %, relative to the weight of the solution, of a poly(2-oxazoline). The casting solution may further include 5-80 wt. %, relative to the weight of the solution, of a solvent for the polymer component, 0-80 wt. %, relative to the weight of the solution, of a latent solvent for the polymer component, as well as 0-70 wt. %, relative to the weight of the solution, of a non-solvent for the polymer component. In some embodiments, the casting solution may include 15-50 wt. %, relative to the weight of the solution, of γ-butyrolactone and 10-50 wt. %, relative to the weight of the solution, of polyethylene glycol or caprolactam.

In some embodiments, the casting solution can have 5-30 wt. %, relative to the weight of the solution, of the aromatic sulfone polymer and poly(2-oxazoline), 5-30 wt. %, relative to the weight of the solution, of hydrophilic polymer, and 20-60 wt. %, relative to the weight of the solution, of solvent.

Not least due to their porous upstream side, the membranes are distinguished by a high throughput and thereby by a high transmembrane flow for water. The membranes according to the invention have preferably a throughput of at least 2000 L/m². In some embodiments, have preferably a throughput of at least 3000 L/m², 3500 L/m², 4000 L/m², 4500 L/m², 5000 L/m², 5500 L/m², 6000 L/m² or 6500 L/m² of filtration media, for example, beer or water.

The invention provides polymeric membranes with superior protein repelling characteristics. Therefore, these membranes block more slowly, show a higher throughput behavior and thus a longer lifetime. These membranes further exhibit an almost asymmetrical structure that is promising for the preparation of highly selective membranes.

The described method provides a membrane in which the aromatic sulfone polymers and the poly(2-oxazoline) are distributed throughout the membrane. The described method further provides a membrane in which the aromatic sulfone polymers and the poly(2-oxazoline) are evenly distributed throughout the membrane. The described method still further provides a membrane in which the aromatic sulfone polymers and the poly(2-oxazoline) are uniformly distributed throughout the membrane.

The described method provides a membrane in which the poly (2-oxazoline) is distributed throughout the membrane. The described method further provides a membrane in which the poly(2-oxazoline) is evenly distributed throughout the membrane. The described method still further provides a membrane in which the poly(2-oxazoline) is uniformly distributed throughout the membrane.

The creation of a porous upstream side in combination with protein repelling characteristics of the membranes can provide better filtration characteristics due to less fouling and higher throughput.

The membranes according to the invention in the form of flat sheets, i.e. the flat membranes according to the invention are suitable in particular for microfiltration. In the membrane, the separating layer or separating region is the layer or region of the membrane having minimal pore size. The separating layer functions to retain certain particles, molecules, or microorganisms in or on the membrane based on the pore size of the separating layer.

In some embodiments, the separating layer can be the isotropic region of the membrane. In some embodiments, the separating layer can be the first asymmetrical region and/or the second asymmetrical region. In some embodiments, the membrane has a first separating layer comprising the first asymmetrical region and a second separating layer comprising the second asymmetrical region. In some embodiments, the membrane has a first separating layer comprising the first asymmetrical region, a second separating layer comprising the second asymmetrical region, and an isotropic region sandwiched between the first and second asymmetrical regions. In some embodiments, the separating layer can be a region other than the first asymmetrical region, the second asymmetrical region and the isotropic region. Membranes of this type have, as a general rule, diameters of the separating pores of 0.01-10 μm, preferably of 0.1-5 μm and more preferably of 0.2-2 μm. Preferably, the flat membrane according to the invention has a thickness of 10-300 μm, more preferably of 30-220 μm. In some embodiments, the supporting layer can be at least one of the isotropic region, the first asymmetrical region and the second asymmetrical region. For example, when the separating layer is the isotropic region of the membrane, t the supporting layer can be the first asymmetrical region and/or the second asymmetrical region.

In some embodiments, a method of using the asymmetric membrane or membrane combination is provided. The asymmetric membrane or membrane combination can be used to filter a liquid composition. The liquid composition can be an aqueous composition, for example, water or beer. In some embodiments, the asymmetric membrane or membrane combination can be used to remove one or more micro-organisms from the liquid composition. The micro-organism may be a bacteria or a yeast, for example, Lactobacillus brevis or Saccharomyces cerevisiae. In some embodiments, a log 10 reduction in colony-forming unit (cfu) count of more than 1, 2, 3, 4, or 5 can be achieved, when filtering the liquid composition through the membrane or membrane combination. In some embodiments, a log 10 reduction in cfu count of 1-7 is achieved, when filtering the liquid composition through the membrane or membrane combination.

The following working examples are intended to be illustrative of the present disclosure and not limiting.

### EXAMPLES

Objects and advantages of this invention are further illustrated by the following examples, but the particular materials and amounts thereof recited in these examples, as well as other conditions and details, should not be construed to unduly limit this invention.

TABLE 1
Materials List

| Description (Abbreviation) | Source |
|---|---|
| e-Caprolactam | BASF SE, Ludwigshafen, Germany |
| g-Butyrolactone | Ashland Industries Deutschland |
| | GmbH, Düsseldorf, Germany |
| Polyethersulfone (PES), | BASF SE, Ludwigshafen, Germany |
| (ULTRASON E6020), | |
| (MW = 72,000 g/mol) | |
| Sulfonated | Maintech Systems |
| polyethersulfone (SPES) | GmbH, Obernburg, |
| (MW = 65,000 g/mol) | Germany |
| Poly(2-ethyl-2-oxazoline (PEtOx) | Kremer Pigmente GmbH & Co, KG, |
| (MW = 50,000 g/mol) | Aichstetten, Germany |
| Glycerol | Inovyn Chlorovinyls Limited, |
| | Knightsbridge, UK |
| Poly(ethylene glycol) (PEG200) | VMP Chemiekontor |
| (MW = 200 g/mol) | GmbH, Siegburg, |
| | Germany |
| Poly(ethylene glycol) (PEG600) | Ter Hell & Co. GmbH, |
| (MW = 600 g/mol) | Hamburg, Germany |

### Method A. Method for Determining Transmembrane Flow (TMF)

Sample discs (90-130 mm diameter) were punched from a membrane sheet. A single disc was placed flat in a sample holder that had a fluid inlet port positioned above the disc and a fluid outlet port positioned below the disc. The holder was sealed with the disc oriented in the holder so that the disc surface with smaller pores faced toward the fluid inlet and the disc surface with larger pores faced toward the fluid outlet. The frontal surface area of exposed membrane was 43.2 cm². Deionized water (at 25° C.) was pumped at a defined pressure of 0.1 to 0.2 bar with the water entering the inlet, flowing through the membrane in the direction of gravity, and then exiting through the outlet port into a receiving vessel. The water was collected for one minute and measured either gravimetrically or volumetrically. The transmembrane flow (TMF) was calculated using Equation 1.

$$TMF [ \frac{mL}{{cm}^{2} \cdot min \cdot bar} ] = \frac{{V}_{W}}{[ {A}_{M} \cdot Δ t \cdot Δ p ]} . \qquad Equation 1$$

where:
V_{W}=Water volume flowing through the membrane sample during the measuring period [mL]
Δt=Measuring time [minutes]
A_{M}=Frontal surface area of the water penetrated membrane sample
Δp=Pressure set during the measurement [bar]

### Method B. Method for Determining Maximum Separating Pore (Bubble Point)

The diameter of the maximum separating pore (dₘₐₓ) was determined by means of the bubble point (BP) method (ASTM No. 128-61 and F316-86), where for example the method described in German Patent DE3617724 (Reichelt) is suitable. As shown in Equation 2, dₘₐₓ results from the vapor pressure P_{B} associated with the bubble point.

dₘₐₓ=s_{B}/P_{B} Equation 2.

where s_{B} is a constant that is primarily dependent on the wetting liquid used during the measurement. For examples of this disclosure the wetting liquid was water. For water, s_{B} is 2.07 μm·bar at 25° C.

### Method C. Method for Determining Membrane Throughput (TP) of Beer Samples

Beer samples were degassed at 0.2 bar and 25° C. for 17 hours prior to the test. The experiment was conducted using a test apparatus with a sample tank and a plunger pump that operated at a constant flow of 80 mL/minute. The backpressure during the filtration was determined using a pressure sensor positioned between the pump and the filter holder.

A membrane disc of 13.7 cm² was cut out of a membrane sheet. The membrane was prewetted with water for 5 minutes and then placed flat in a filter holder. The holder contained a fluid inlet port positioned above the disc and a fluid outlet port positioned below the disc. The beer was pumped into the sealed holder through the inlet port, flowing through the membrane in the direction of gravity, and exiting the outlet port into a receiving vessel. The membrane was oriented in the holder so that the surface of the membrane having larger pores and higher porosity (i.e. the upstream membrane surface) faced towards the inlet port. Before the measurement started, the apparatus was filled with the beer to be tested and the filled apparatus was degassed using a vent valve. The filtration was stopped when a backpressure of 1.0 bar was reached. The filtration time was recorded.

The total volume of beer passing through the filter was calculated from the product of the flow (L/minute) and the elapsed time (minutes) until a backpressure of 1.0 bar was reached. The throughput (L/m² at 1.0 bar) was determined as the total volume of beer (L) per frontal surface area of the filter (m²) at (1.0 bar). Two types of beer samples, pilsner and Belgian-style witbier, were tested.

### Method D. Method for Determining Reduction of Lactobacillus brevis or Saccharomyces cerevisiae in a Sample Following Membrane Filtration

Lactobacillus brevis and Saccharomyces cerevisiae were obtained from DSMZ German Collection of Microorganisms and Cell Cultures, Braunschweig, Germany.

A streak plate of L. brevis was prepared on MRS agar from a frozen stock sample and incubated at 30° C. for 72 hours in the absence of oxygen. L. brevis cultures were initiated by transferring a single colony from the streak plate into 10 mL of MRS media in a sterile culture flask. Culture flasks of L. brevis were incubated at 30° C. for 72 hours. The resulting cell culture was diluted with acetic acid buffer (pH 4.0), in order to adjust a cell number to a minimal value of about 2×10⁶ to 2×10⁷ cfu/mL (cfu=colony forming units). This was the starting concentration of bacteria for the filtration.

A streak plate of S. cerevisiae was prepared on Sabouraud agar from a frozen stock sample and incubated at 30° C. for 72 hours. S. cerevisiae cultures were initiated by transferring a single colony from the streak plate into 1 L of yeast medium in a sterile culture flask. Culture flasks of S. cerevisiae were incubated with shaking at 30° C. for 24 hours. The culture was serially diluted with sterile, distilled water to provide a sample with S. cerevisiae concentration of approximately 2×10⁶ to 2×10⁷ cfu/mL results. This was the starting concentration of bacteria for the filtration.

A sample disc (127 cm²) was cut from a membrane and placed flat in a filter holder. The sealed filter holder contained a fluid inlet port positioned above the disc and a fluid outlet port positioned below the disc. The culture sample (1 L) was pressure filtered (2.07 bar) with the culture sample entering the holder through the inlet port, flowing through the membrane in the direction of gravity, and exiting the outlet port into a receiving vessel. The membrane was oriented in the holder so that the surface of the membrane having larger pores and higher porosity (i.e. the upstream membrane surface) faced towards the inlet port. The filtrate (1 L) was collected in a receiving vessel using sterile methods.

For L. brevis, the filtrate sample was serially diluted with sterile, distilled water and 0.2 mL of each diluted sample was streaked onto an MRS agar plate. Alternatively, if a high retentive performance was expected, the complete filtrate was filtered undiluted through a 0.2 μm membrane sterile filter and the filter was transferred onto an MRS agar plate. The inoculated plates were incubated at 30° C. for 7 days and the colony forming units (cfu) in each plate were counted by visual examination. The corresponding concentration of L. Brevis in the test sample and filtrate sample (cfu/mL)was calculated based on the dilution factor.

For S. cerevisiae, the complete filtrate was filtered undiluted through a 0.2 micron membrane sterile filter and the filter was transferred onto a Sabouraud agar plate. The inoculated plate was incubated at 30° C. for 7 days and the colony forming units (cfu) in each plate were counted by visual examination. The corresponding concentration of S. cerevisiae in the test sample and filtrate sample (cfu/mL) was calculated based on the dilution factor.

Bacterial retention by the membrane was calculated according to Equation 3 as the logarithmic reduction value (LRV).

LRV=log₁₀[conc. of bacteria in sample before filtration (cfu/mL)/conc. of bacteria in the filtrate (cfu/mL)] Equation 3

### Method E. Method for Determining the Viscosity of a Casting Solution

The viscosity of a casting solution was determined at 60° C. and a shear rate of 10 s⁻¹ using a HAAKE RheoStress 1 rheometer (Thermo Fisher Scientific, Waltham, MA) with a Z20DIN sensor device (Thermo Fisher Scientific, Waltham, MA).

### Example 1

A mixture of 50 wt. % of γ-butyrolactone and 50 wt. % of ε-caprolactam, conditioned to 40° C. in a temperature adjustable tank, was stirred and 18.75 kg of poly(2-ethyl-2-oxazoline) was added. The tank was heated to 50° C. and the mixture was stirred for 2 hours. Next, 1.5 kg of glycerol and 1.2 kg of water were added. The mixture was stirred for 30 minutes at 50° C. and then 1.95 kg of sulfonated polyethersulfone (SPES, with a degree of sulfonation of 5%) and 22.8 kg of polyethersulfone (PES) were added. The mixture was stirred for 10 minutes. The oxygen was largely removed from the tank by creation of a vacuum and the application of nitrogen. The tank was heated to 50° C. and a homogeneous solution was obtained after 24 hours of intensive stirring. The solution was then degassed by means of a vacuum. The resulting casting solution had a viscosity of 7.4 Pa s and a tan δ of 85.6 at 60° C.

The finished casting solution was poured out by means of a casting mold conditioned to 50° C. onto a metal casting roller conditioned to 40° C. to form a film with a thickness of about 160 micrometers. The film located on the casting roller was conveyed through a climate-controlled zone where for about 35 seconds it was exposed to a climate of 40° C. and 40% relative humidity. From the climate-controlled zone, the film was introduced into a coagulation bath of water conditioned to 40° C. After a retention time of 35 seconds for the formation of the membrane structure, the membrane was withdrawn from the coagulation bath and conveyed to the wash baths by means of a drawing-off roller at a speed increased by 16% in comparison to the casting roller speed. With the increase in roller speed, the membrane structure was drawn in order to open the surface pores. In the wash baths, the membrane was fixed in water at temperatures increasing stepwise to 90° C. to extract solvent and polymeric additives from the membrane. The membrane was dried using a drum dryer (60-80° C.) Within the wash and drying areas, there was a further roller speed increase of about 5%.

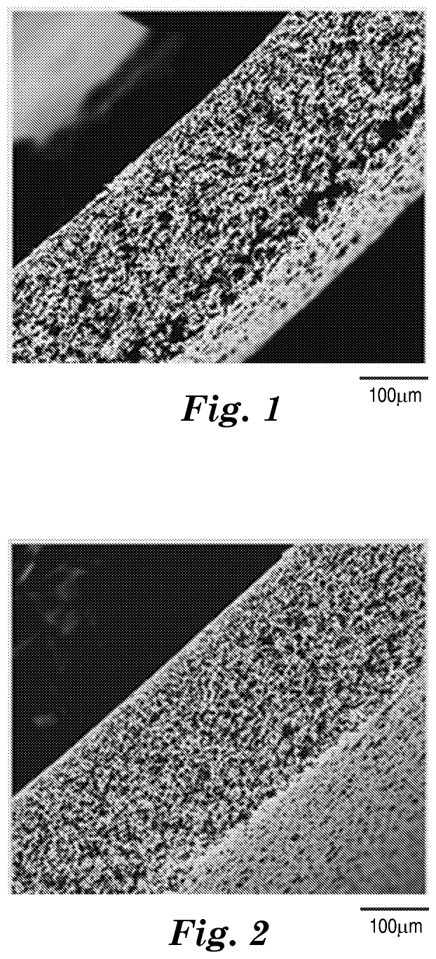

The finished membrane was a hydrophilic, asymmetric membrane. An SEM image of the cross-sectional structure of the membrane is provided in FIG. 1. The membrane had a cross-sectional structure with an interior separating layer (i.e. the layer with the minimal pore size) at a distance of about 5 μm from one surface of the membrane (downstream surface). The pore sizes of the separating layer increased toward the membrane interior forming the second asymmetrical region. The pore size then remained essentially unchanged over a region of about ¾ of the wall thickness forming the essentially isotropic region. Prior to reaching the opposite surface (upstream surface) of the membrane, the pore sizes increased forming the first asymmetrical region. Pores at both surfaces of the membrane were elongated in the direction of stretching.

Membrane thickness, transmembrane flow and bubble point measurements of the membrane are reported in Table 2. Membrane throughput measurements using beer as the fluid are reported in Table 3. Reduction in microbial count (LRV) after filtering samples of either L. brevis or S. cerevisiae is reported in Table 4.

### Example 2

The same procedure as reported in Example 1 was followed with the exception that the coagulation water bath was conditioned at 37° C., instead of at 40° C.

The finished membrane was a hydrophilic, asymmetric membrane. An SEM image of the cross-sectional structure of the membrane is provided in FIG. 2. The membrane had a cross-sectional structure with an interior separating layer (i.e. the layer with the minimal pore size) at a distance of about 5 micrometers from one surface of the membrane (downstream surface). The pore sizes of the separating layer increased in the direction toward the membrane interior forming the second asymmetrical region. The pore size then remained essentially unchanged over a region of about ⅘ of the wall thickness forming the isotropic region. Prior to reaching the opposite surface (upstream surface) of the membrane, the pore sizes increased forming the first asymmetrical region. Pores at both surfaces of the membrane were elongated in the direction of stretching.

Membrane thickness, transmembrane flow and bubble point measurements of the membrane are reported in Table 2. Membrane throughput measurements using beer as the fluid are reported in Table 3. Reduction in microbial count (LRV) after filtering samples of either L. brevis or S. cerevisiae is reported in Table 4.

### Example 3

The same procedure as described in Example 1 for formation of a flat sheet membrane was followed with the exception that the drawing-off roller was operated at the same speed of the casting roller resulting in no stretching of the membrane.

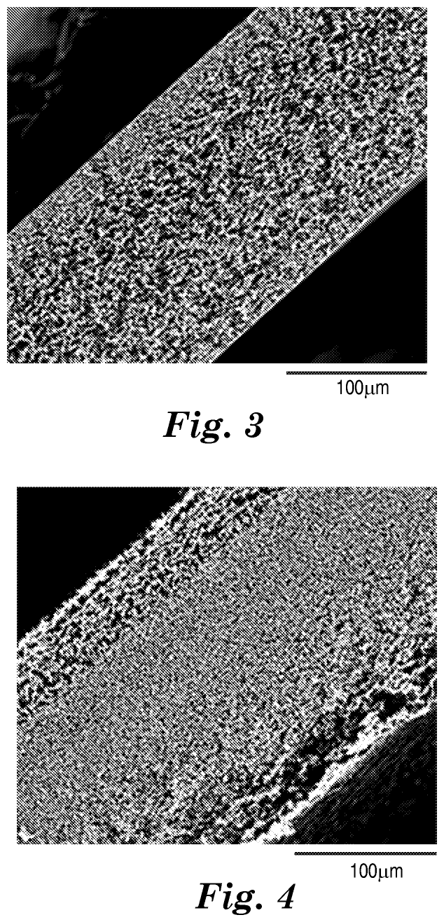

The finished membrane was a hydrophilic, asymmetric membrane. An SEM image of a membrane is provided in FIG. 3 showing the cross-sectional structure of the membrane. The membrane had a cross-sectional structure with the two asymmetrical regions being separating layers. The first separating layer was adjacent to the first membrane surface and the pore sizes increased in the direction toward the inner part of the membrane forming the first asymmetrical region. The pore size remained essentially unchanged over a mid-section of the membrane forming the isotropic region. The pore sizes then began to decrease in the direction toward the second surface forming the second asymmetrical region as the second separating layer.

Membrane thickness, transmembrane flow and bubble point measurements of the membrane are reported in Table 2. Membrane throughput measurements using beer as the fluid are reported in Table 3. Reduction in microbial count (LRV) after filtering samples of either L. brevis or S. cerevisiae is reported in Table 4.

TABLE 2
Transmembrane Flow (TMF) and Bubble
Point Measurements of Membranes

| | Membrane | Transmembrane | |
|---|---|---|---|
| | Thickness | Flow | Bubble Point |
| Membrane | (μm) | (mL/(cm² · min · bar)) | (bar) |
| Example 1 | 140 | 285 | 0.9 |
| Example 2 | 140 | 330 | 1.3 |
| Example 3 | 110 | 160 | 1.5 |

TABLE 3
Membrane Throughput Determined by Method C

| | Throughput | Throughput of |
|---|---|---|
| | of Pilsner | Belgian Style |
| Membrane | Beer (L/m²) | Witbier (L/m²) |
| Example 1 | 7000 | >900 |
| Example 2 | 1900 | 400 |
| Example 3 | 1000 | 300 |

TABLE 4
Log Reduction in Microorganism
Content Determined by Method D

| | Log Reduction Value in L. | Log Reduction Value in S. |
|---|---|---|
| Membrane | brevis cfu count (LRV) | cerevisiae cfu count (LRV) |
| Example 1 | 2.7 | >7 |
| Example 2 | 6.0 | >7 |

### Example 4

A mixture of 67.2 kg of a mixture of 50 wt. % of γ-butyrolactone and 50 wt. % of ε-caprolactam, conditioned to 40° C. in a temperature adjustable tank was stirred and 10.5 kg of finely dispersed poly(2-ethyl-2-oxazoline) was added with stirring until the mixture was homogeneous. Next, 26.1 kg of PEG200, 26.1 kg of PEG600 and 0.6 kg of water were added followed by the addition of 19.5 kg of polyethersulfone (PES). The PES was sprinkled into the tank with stirring and the reaction was maintained for 4 hours. The oxygen was then largely removed from the tank by creation of a vacuum and the application of nitrogen. The tank was heated to 50° C. and a homogeneous solution was obtained after 24 hours of intensive stirring. The solution was degassed by means of a vacuum. The resulting casting solution had a viscosity of 1.2 Pa s and a tan δ of 56.7 at 60° C.

The finished casting solution was poured out by means of a casting mold conditioned to 50° C. and 60% relative humidity onto a metal casting roller conditioned to 70° C. to form a film with a thickness of about 180 micrometers. The film located on the casting roller was conveyed through a climate-controlled zone where for about 35 seconds it was exposed to a climate of 50° C. relative humidity. From the climate-controlled zone, the film was introduced into a coagulation bath of water conditioned to 70° C. After formation of the membrane structure, the membrane was withdrawn by means of a drawing-off roller and subsequently conveyed to the wash baths. In the wash baths, the membrane was fixed in water at temperatures increasing incrementally to 90° C. in order to extract solvent and polymeric additives from the membrane. The membrane was dried using a drum dryer (60-80° C.) Within the wash and drying areas, there was a further roller speed increase of about 9%.

The finished membrane was a hydrophilic, asymmetric membrane. An SEM image of a membrane is provided in FIG. 4 showing the cross-sectional structure of the membrane. The membrane had a cross-sectional structure of two asymmetrical regions with an isotropic region sandwiched between the asymmetrical regions. The first asymmetrical region had a first open porous layer adjacent to one surface of the membrane with the pore sizes in the region decreasing in the direction toward the inner part of the membrane. The pore size remained essentially unchanged over a mid-section of the membrane forming the isotropic region. The pore sizes increase in the direction toward the opposite surface of the membrane forming the second asymmetrical region. As a result, the inner isotropic region was the separating layer. In the construction, the first asymmetrical region had larger pores than in the second asymmetrical region and both the first and second asymmetrical regions had larger pores than in the isotropic region. The TMF of the membrane was 45 mL/(cm²·min·bar) and the bubble point was 2.1 bar.

### Example 5

The procedure as described in Method C was used to measure the throughput of a pilsner beer using a stack of two membranes in place of a single membrane. The stack consisted of two membrane discs from Example 1. In the assembly, the first membrane disc in the stack was placed directly on top of the second membrane disc so that in operation the beer sample flowed initially through the first disc and then through the second disc. The discs were oriented in the stack so that for each membrane the upstream surface (surface with larger pores) of the membrane faced toward the inlet port of the filter holder. Membrane throughput using beer as the fluid is reported in Table 6.

### Example 6

The procedure as described in Example 5 was followed with the exception that the membrane discs from Example 1 were replaced with membrane discs from Example 2. The discs were oriented in the stack so that for each membrane the upstream surface (surface with larger pores) of the membrane faced toward the inlet port of the filter holder. Membrane throughput using beer as the fluid is reported in Table 6.

### Example 7

The procedure as described in Example 5 was followed with the exception that the one disc from Example 1 and 1 disc from Example 2 was used in the stack. The disc from Example 1 was the first membrane in the stack and the disc from Example 2 was the second membrane in the stack. In the assembly, the first membrane disc (Example 1) in the stack was placed directly on top of the second membrane disc (Example 2) so that in operation the beer sample flowed initially through the first disc and then through the second disc. The discs were oriented in the stack so that for each membrane the upstream surface (surface with larger pores) of the membrane faced toward the inlet port of the filter holder. Membrane throughput using beer as the fluid is reported in Table 6.

TABLE 6
Throughput of Beer Sample through a Membrane Stack

| | 1^{st} | 2^{nd} | |
|---|---|---|---|
| | Membrane | Membrane | Throughput of |
| Procedure | Disc in | Disc in | Pilsner Beer |
| of | Stack | Stack | (L/m²) |
| Example | Example 1 | Example 1 | 5800 |
| 5 | | | |
| Example | Example 2 | Example 2 | 1500 |
| 6 | | | |
| Example | Example 1 | Example 2 | 2800 |
| 7 | | | |

### Example 8

The procedure as described in Method D was used to measure the log reduction in L. brevis (cfu count) on filtration of a culture sample through a two disc stack of membrane filter discs. The stack consisted of two membrane discs from Example 1. In the assembly, the first membrane disc in the stack was placed directly on top of the second membrane disc so that in operation the culture sample flowed initially through the first disc and then through the second disc. The discs were oriented in the stack so that for each membrane the upstream surface (surface with larger pores) of the membrane faced toward the inlet port of the filter holder. The reduction in L. brevis count (LRV) after filtering the sample through the membrane stack is reported in Table 7.

### Example 9

The procedure as described in Example 8 was followed with the exception that the membrane discs from Example 1 were replaced with membrane discs from Example 2. The discs were oriented in the stack so that for each membrane the upstream surface (surface with larger pores) of the membrane faced toward the inlet port of the filter holder. The reduction in L. brevis count (LRV) after filtering the sample through the membrane stack is reported in Table 7.

### Example 10

The procedure as described in Example 8 was followed with the exception that the one disc from Example 1 and 1 disc from Example 2 was used in the stack. The disc from Example 1 was the first membrane in the stack and the disc from Example 2 was the second membrane in the stack. In the assembly, the first membrane disc in the stack was placed directly on top of the second membrane disc so that in operation the culture sample flowed initially through the first disc and then through the second disc. The discs were oriented in the stack so that for each membrane the upstream surface (surface with larger pores) of the membrane faced toward the inlet port of the filter holder. The reduction in L. brevis count (LRV) after filtering the sample through the membrane stack is reported in Table 7.

TABLE 7
Log Reduction in Microorganism
Content Determined by Method D

| | 1^{st} | | |
|---|---|---|---|
| | Membrane | 2^{nd} | Log Reduction Value |
| Procedure | Disc in | Membrane | in L. brevis |
| of | Stack | Disc in Stack | cfu count (LRV) |
| Example 8 | Example 1 | Example 1 | 5 |
| Example 9 | Example 2 | Example 2 | >8 |
| Example | Example 1 | Example 2 | 7 |
| 10 | | | |

All references and publications cited herein are expressly incorporated herein by reference in their entirety into this disclosure. Illustrative embodiments of this invention are discussed and reference has been made to possible variations within the scope of this invention. For example, features depicted in connection with one illustrative embodiment may be used in connection with other embodiments of the invention. These and other variations and modifications in the invention will be apparent to those skilled in the art without departing from the scope of the invention, and it should be understood that this invention is not limited to the illustrative embodiments set forth herein. Accordingly, the invention is to be limited only by the claims provided below and equivalents thereof.

1. An asymmetric membrane comprising:
a membrane wall with a first and a second porous surface and an interior situated between the surfaces;
a first asymmetrical region towards the first surface;
a second asymmetrical region towards the second surface;
wherein the asymmetric membrane is made from a polymeric blend comprising an aromatic sulfone polymer and a poly(2-oxazoline); and
wherein the asymmetric membrane is in the form of a flat sheet.

2. The asymmetric membrane of claim 1, wherein the aromatic sulfone polymer comprises a polysulfone or polyethersulfone.

3. The asymmetric membrane of claim 1, wherein the poly(2-oxazoline) is poly(2-ethyl-2-oxazoline) (PEtOx).

4. The asymmetric membrane of claim 1, wherein the first asymmetrical region and/or the second asymmetrical region is a separating layer.

5. The asymmetric membrane of claim 1, wherein the pore size of the first asymmetrical region is larger than the pore size of the second asymmetrical region.

6. The asymmetric membrane of claim 1, wherein the polymeric blend further comprises a hydrophilic polymer selected from polyvinylpyrrolidone, polyethylene glycol, polyvinyl alcohol, polyglycol monoester, polysorbitate, carboxymethylcellulose, polyacrylic acid, polyacrylate, or a modification or a copolymer of these polymers.

7. The asymmetric membrane of claim 6, wherein the hydrophilic polymer is present in a concentration of 1 to 75 wt. % relative to the weight of the membrane.

8. The asymmetric membrane of claim 6, wherein the polymeric blend comprises more than 7 wt. % or less than 3 wt. % of polyvinylpyrrolidone.

9. The asymmetric membrane of claim 1, wherein the polymeric blend does not comprise polyvinylpyrrolidone.

10. The asymmetric membrane of claim 1, wherein the polymeric blend further comprises a solvent selected from butyrolactone, glycerin, caprolactam, or combination thereof.

11. The asymmetric membrane of claim 1, wherein the polymeric blend is a hydrophobic polymeric blend.

12. The asymmetric membrane of claim 1, further comprising an essentially isotropic region between the first asymmetrical region and the second asymmetrical region.

13. The asymmetric membrane of claim 12, wherein the isotropic region is a separating layer.

14. The asymmetric membrane of claim 12, wherein the pore size of the isotropic region is less than the pore size of the first asymmetrical region and the pore size of the second asymmetrical region.

15. The asymmetric membrane of claim 12, wherein the pore size of the isotropic region is larger than the pore size of the first asymmetrical region and the pore size of the second asymmetrical region.

16. The asymmetric membrane of claim 1, pores in the first and the second asymmetrical regions are elongated in a direction.

17. The asymmetric membrane of claim 1, the pore size of the first asymmetrical region is more than 2 times larger than the pore size of the second asymmetrical region.

18. A membrane combination, comprising at least two asymmetric membranes of claim 1; wherein the at least two asymmetric membranes are stacked adjacent to each other.

19. A method, the method comprising:
producing a casting solution comprising an aromatic sulfone polymer and a poly(2-oxazoline), conditioning the casting solution to a casting temperature;
pouring the casting solution onto a carrier to form a film;
conveying the film located on the carrier through a climate-controlled zone;
introducing the film located on the carrier into a coagulation medium and initiating the coagulation of the film for the formation of a membrane structure; and
stabilizing the membrane structure in the coagulation medium.

20. The method of claim 19, further comprising withdrawing the membrane structure from the carrier with a speed of v2, wherein the carrier has a speed v₁ and the speed v₂ is greater than the speed v₁.

21-29. (canceled)
